(19) United States
(12) Patent Application Publication
(10) Pub. No.: US 2013/0166505 A1
(43) Pub. Date: Jun. 27, 2013

(54) MONITORING REPLICATION LAG BETWEEN GEOGRAPHICALLY DISPERSED SITES

(71) Applicants: Noam Peretz, Tel Mond (IL); Tomer Harel, Beit Yitzhak (IL)

(72) Inventors: Noam Peretz, Tel Mond (IL); Tomer Harel, Beit Yitzhak (IL)

(21) Appl. No.: 13/335,860

(22) Filed: Dec. 22, 2011

(51) Int. Cl. G06F 17/30

(52) U.S. Cl. 707/611; 707/E17.005

(57) ABSTRACT

A method for detecting replication lag is described. In an embodiment, a local timestamp is generated at a first computer. The local timestamp is stored in an electronic folder. If a replication triggering event occurs, the electronic folder is replicated at one or more target computers. If an update triggering event occurs, the local timestamp in the electronic folder is updated. If a detection triggering event occurs, a request for at least a portion of the electronic folder representing the local timestamp is sent to at least one target computer of the one or more target computers. At least the portion of the electronic folder representing the local timestamp is received from the at least one target computer. If the time difference between one or more of the received timestamps and the local timestamp exceeds a threshold amount, a system event is generated.

### TECHNICAL FIELD

The present disclosure generally relates to the field of data replication among computers. The disclosure relates more specifically to techniques for detecting and monitoring replication lag.

### BACKGROUND

The approaches described in this section could be pursued, but are not necessarily approaches that have been previously conceived or pursued. Therefore, unless otherwise indicated herein, the approaches described in this section should not be assumed to be prior art to the claims in this application and are not admitted to be prior art by inclusion in this section.

Replication in data processing is a process of sharing information so as to ensure consistency between redundant resources to improve reliability, fault-tolerance, or accessibility. Replication can take the form of data replication where the same data is stored on multiple devices, or computation replication in which the same computing task is executed many times. In addition, a replication system generally can be classified as an active replication system or a passive replication system. Active replication takes place when a request is serviced by performing the request at every replica. Passive replication occurs when a request is processed at a single replica and its state is transferred to the other replicas. A variation of passive replication wherein one master replica is designated to process all requests is sometimes known as a primary-backup or master-slave system.

Additionally, the benefits of replication can be increased by replicating to geographically remote sites. Having replicas at geographically remote sites allows for recovery in case of natural or human-induced disasters such as vandalism, fire, flood, or storms. These types of disasters are typically localized to one geographical area. Replicas located outside the zone of danger will therefore be safe from the disaster and can be used to recover the replicated data should the afflicted site be destroyed or otherwise become inaccessible.

However, the benefit of maintaining the remote sites is dependent upon ensuring that the replicated data remains up to date. If an afflicted site has updates which have not yet been propagated to the replicas, the updates may be lost. The difference in time at which different sites perform replication, known as replication lag, is an indicator of the reliability of replication. Knowing the amount of replication lag also could be important to determine whether a distributed system complies with one or more elements of a service level agreement (SLA) between a vendor of the distributed system and a user or customer.

### BRIEF DESCRIPTION OF THE DRAWINGS

In the drawings:

FIG. 1 illustrates a network upon which an embodiment may be implemented.

FIG. 2 illustrates an example of a folder in which an embodiment has inserted a timestamp.

FIG. 3 illustrates an embodiment of the primary site in state diagram form

FIG. 4 illustrates an embodiment of a remote site in state diagram form.

FIG. 5 illustrates an alternative embodiment of the primary site in state diagram form.

FIG. 6 illustrates an alternative embodiment of the remote site in state diagram form.

FIG. 7 illustrates a computer system upon which an embodiment may be implemented.

### DESCRIPTION OF EXAMPLE EMBODIMENTS

Monitoring replication lag between geographically dispersed sites is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
   2.1 Primary Site Overview
   2.2 Remote Site Overview
   2.3 Alternative Design for Primary and Remote Sites
   2.3 Process of Preventatively Detecting Replication Lag
   2.4 Process of Detecting Replication Lag in a Peer to Peer System
3.0 Implementation Mechanisms—Hardware Overview
4.0 Extensions and Alternatives

1.0 Overview

In an embodiment, a method for detecting replication lag is described. Various other embodiments may implement the processes disclosed herein using processing steps or functional blocks that are ordered differently than any order specified or implied herein for a particular embodiment.

In an embodiment, a local timestamp is generated at a first computer. The local timestamp is stored in an electronic folder. If a replication triggering event occurs, then the electronic folder is replicated at one or more target computers. If an update triggering event occurs, then the local timestamp in the electronic folder is updated. If a detection triggering event occurs, then a request for at least a portion of the electronic folder representing the local timestamp is sent to at least one target computer of the one or more target computers. At least the portion of the electronic folder representing the local timestamp is received from the at least one target computer. If the time difference between one or more of the received timestamps and the local timestamp exceeds a threshold value, then a system event is generated. The system event may indicate the presence of excess replication lag time.

In another embodiment, a local timestamp is generated at a first computer. The local timestamp is stored in an electronic folder. If a replication triggering event occurs, then the electronic folder is replicated at one or more target computers. If an update triggering event occurs, then the local timestamp in the electronic folder is updated. If a receive triggering event occurs, then at least a portion of the electronic folder representing the local timestamp is received from at least one target computer of the one or more target computers. The received timestamp is stored. If the time difference between one or more of the received timestamps and the local timestamp exceeds a threshold value, then a system event is generated.

In other embodiments, the invention encompasses a computer apparatus and a computer-readable medium configured to carry out the foregoing processes.

Embodiments generally provide a method to monitor lag time involved in file replication to multiple sites in a manner that is independent of the underlying replication technology and any time differences between local and remote sites. Embodiments may be implemented in a variety of distributed systems or systems that provide high availability, hot standby replication, data redundancy or replicated file storage. An example is Cisco Active Network Abstraction (ANA), commercially available from Cisco Systems, Inc., San Jose, Calif., and which supports network management systems by providing geographical redundancy of network management data for purposes of disaster recovery.

2.0 Structural and Functional Overview

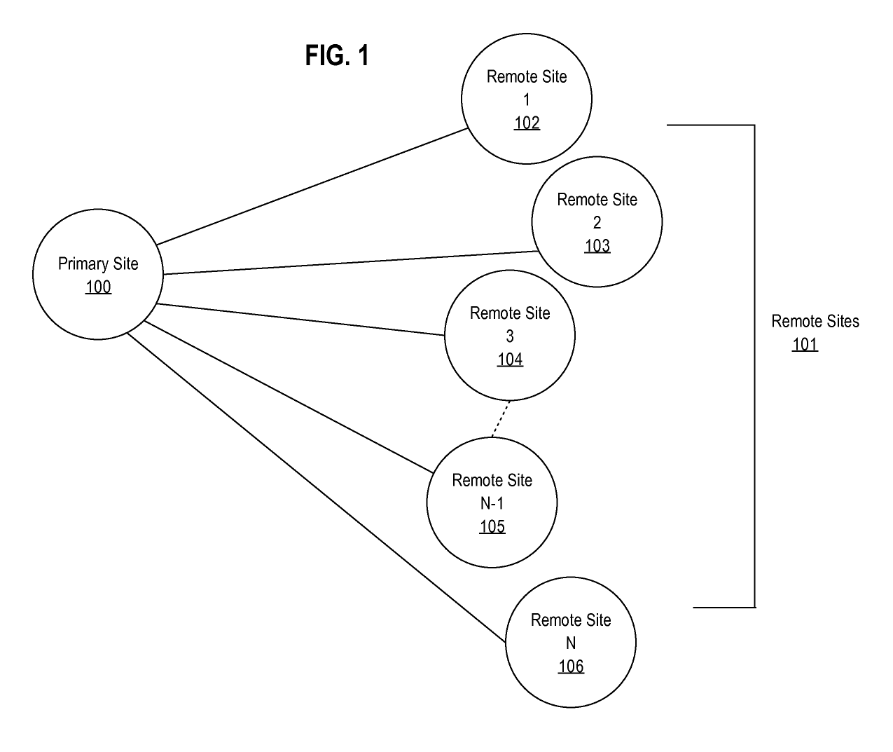

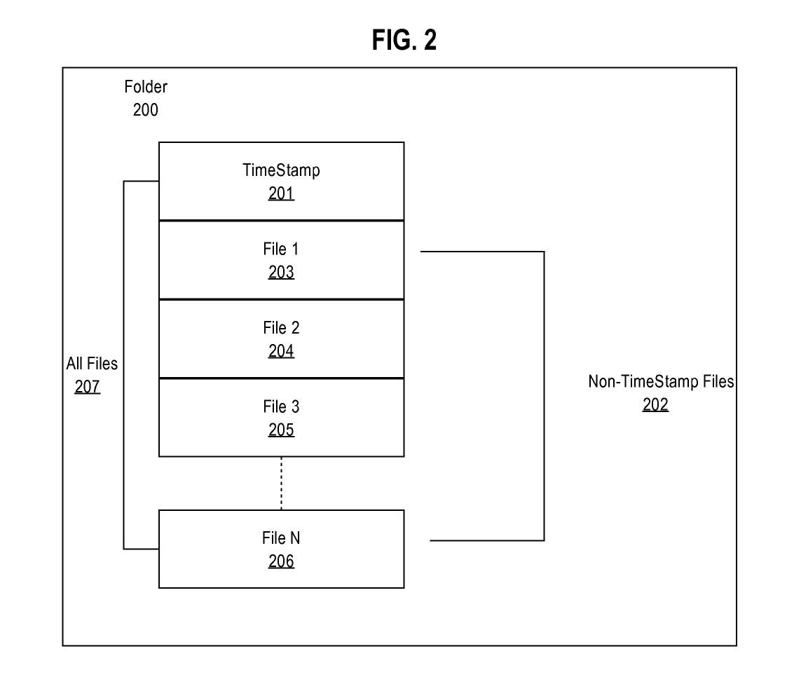

FIG. 1 illustrates an example network upon which an embodiment may be implemented. FIG. 2 illustrates an example of a folder in which an embodiment has inserted a timestamp. To illustrate monitoring replication lag between geographically remote sites in a clear example, FIG. 1, FIG. 2 relate to an embodiment that assumes the existence of a primary site 100 and several remote sites 101. However, embodiments are not dependent on the existence of multiple remote sites and can work with even a single remote site.

Additionally, for purposes of illustrating a clear example, it will be assumed that a folder 200 has been selected for monitoring at the primary site. Folder 200 may be, for example, a logical folder in the filesystem of a computer maintained using the operating system of the computer. The folder 200 may contain, or come to obtain, one or more files 202 representing data which is to be backed up at the remote sites 101. Files such as files 203, 204, 205, 206 shown in FIG. 2 may comprise any form of files or data. Examples include word processing files, database files, graphics files, etc. Any number of files may be provided in folder 200 and any number of folders may exist at a site; the particular numbers of files and folders shown in FIG. 2 are provided solely to illustrate one clear example.

Primary site 100 and remote sites 102, 103, 104, 105, 106 each comprise at least one computer and at least one data repository. For example, sites 100, 102 each may comprise end station computing devices such as a database server, instances of database clients and database servers, or other computing devices that are associated with data repositories for replication. The sites may comprise network infrastructure elements such as routers, switches or other internetworking devices that maintain replicated data stores, such as routing tables, forwarding tables, BGP tables, or similar data. Primary site 100 is termed “primary” only to indicate that it is a source of data to be replicated to one or more of the remote sites 102, 103, 104, 105, 106. The same site may operate at different times in the role of a primary site and a remote site.

The primary site 100 further comprises at least a processor, memory and logic that is configured to perform the functions that are described herein for a primary site in any embodiment of a primary site. Each of the remote sites 102, 103, 104, 105, 106 further comprises at least a processor, memory and logic that is configured to perform the functions that are described herein for a remote site in any embodiment of a remote site. A particular site may contain logic implementing functions of both a primary site and a remote site to be used at different times for different data, and parallel operations may be supported in which a particular site is acting as a primary site for a first dataset and acting as a remote site for a second dataset.

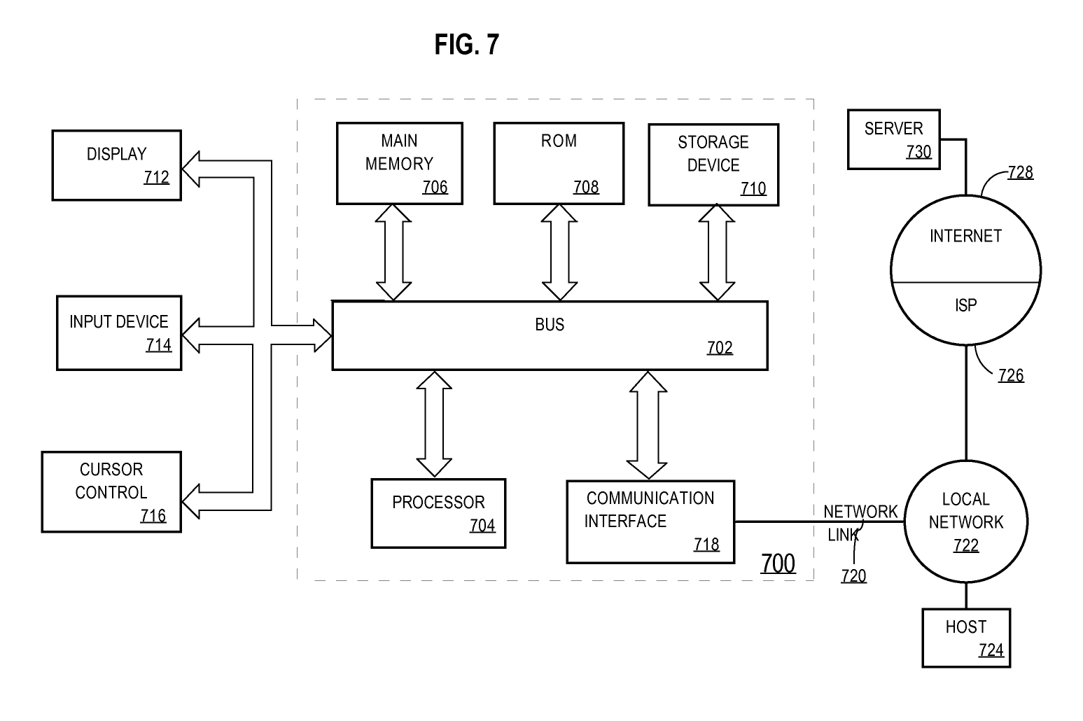

The logic that implements functions of a primary site or secondary site may be implemented in the form of instructions recorded on one or more non-transitory computer-readable media of the type further described herein with reference to FIG. 7 which, when loaded and executed in a general-purpose computer, causes the general-purpose computer to perform the functions described herein. The logic that implements functions of a primary site or secondary site may be implemented in the form of electronic digital logic such as one or more application-specific integrated circuits (ASICs), field programmable gate arrays, or other logic. For example, in one embodiment either a primary site or a remote site may comprise a special- purpose computer.

2.1 Example Structure and Operation of a Primary Site

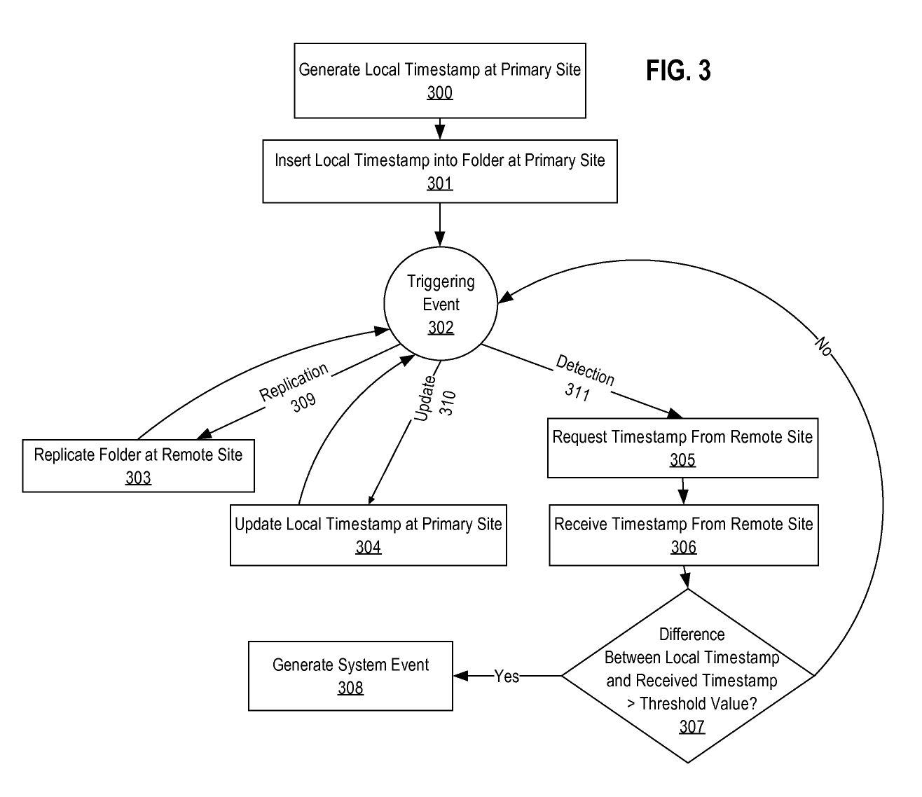

FIG. 3 illustrates an embodiment of a primary site in state diagram form. At block 300, the primary site 100 generates a local timestamp 201, which may be stored, for example, at least transiently in main memory of the primary site computer. In some embodiments the timestamp value could be represented as Coordinated Universal Time (UTC) seconds; however other representations of time will work equally as well. In other embodiments, the primary site 100 might generate multiple timestamps 201 in order to increase the reliability of the system. Certain aspects of FIG. 3 may be implemented, for example, as schedule processes such as cron jobs.

At block 301, local timestamp 201 is inserted into the folder 200 which had been selected for monitoring at the primary site 100. In some embodiments, the selected folder may be the first or top-most directory in the hierarchical structure of the file system and may be referred to as the “root folder” or “root directory”. In some embodiments the local timestamp 201 alone is inserted into the folder. However, in other embodiments multiple timestamps may be inserted, especially if multiple timestamps were generated at block 300. It will be apparent that clock synchronization between the primary site and the remote sites is not critical and that a change to a clock value at a standby site will not impact the monitoring process described herein which relies on the local timestamp of the primary site. After inserting the timestamp 201 into the folder 200, the primary site 100 enters the state of block 302 at which the primary site waits for one or more triggering events.

One potential triggering event at block 302 is a replication triggering event 309. In some embodiments, inserting the local timestamp into the folder at the primary site 100, as in block 301, causes a replication triggering event 309 in order to make an initial replication take place as seen in block 303. Replication at block 303 may use an existing replication mechanism that the primary site and remote sites have already implemented for the purpose of performing general-purpose file replication; for example, rsync may be used. In an embodiment, replicating folders that contain timestamps, in block 303 and all other blocks described herein that involve replicating folders that contain timestamps, always uses the same replication mechanism that that the primary site and remote sites have implemented or are using for general purpose file replication; this approach ensures that accurate time measures are obtained, used and compared.

The initial replication of block 303 ensures that the remote sites 101 will have a timestamp 201 in their version of the folder 200. In other embodiments, replication triggering events 309 can be generated every set period of time or based on some other predefined function. In still other embodiments, a replication triggering event 309 may be generated in response to receiving a message from the remote sites 101 requesting a replication. Since it is anticipated that a replication triggering event 309 may occur at any time, the specifics of when and how a site chooses to generate replication triggering events 309 is not critical.

The result of a replication triggering event 309 is that the folder 200 at the primary site 100 along with one or more associated files 207 will be replicated, at block 303, at the remote sites 101. Since the local timestamp 201 was inserted at block 301 into the folder 200 at the primary site 100, when the folder 200 is replicated at block 303 to the remote sites 101, the timestamp 201 is replicated along with the folder. In one embodiment, the replication at block 303 is handled by a replication program such as rsync. However, the specifics of the replication process are not critical and any replication technique may be used. Additionally, some embodiments may choose to replicate the folder 200 to all remote sites 101 at once in a synchronous fashion or continue with other tasks while spreading out the replications over time in an asynchronous fashion.

Another potential triggering event that may occur at block 302 is an update triggering event 310. In some embodiments an update triggering event 310 is generated every set period of time. In other embodiments, an update triggering event 310 may occur when other non-timestamp files 202 in the folder 200 have been modified. Since it is anticipated that an update triggering event 310 may occur at any point in time, the specifics of when and how a system chooses to generate update triggering events 310 are not critical. In an embodiment, update triggering events 300 typically do not occur so infrequently as to significantly lag behind modifications to the folder 200.

The result of an update triggering event 310 is that the local timestamp 201 in the folder 200 at the primary site 100 will be updated at block 304. Updating at a primary site may comprise modifying a timestamp in a file that is stored in the filesystem of the primary site. In some embodiments, block 304 will involve updating only a single timestamp 201. However, especially if multiple timestamps were generated at block 301, an embodiment could potentially update multiple timestamps.

Another potential triggering event at block 302 is a detection triggering event 311. In some embodiments a detection triggering event 311 is generated every set period of time. In an embodiment, the period of time between detection triggering events may correspond to the threshold at block 307. However, since it is anticipated that detection triggering events 311 may occur at any point in time, the specifics of when and how a system chooses to generate its detection triggering events 311 are not critical.

The result of a detection triggering event 311 is that the primary site 100 will request, at block 305, the timestamp 201 back from the remote sites 101. In some embodiments the primary site 100 will request the timestamp 201 back from all remote sites 101, while in others the primary site 100 may select a single remote site or a subset of remote sites for which to request, at block 305, the timestamp 201. In still other embodiments, the primary site might request multiple timestamps back from the remote sites at once, especially if multiple timestamps were generated at block 300.

Next, the primary site 100 will receive at block 306 the remote versions of the local timestamp 201 from the remote sites 101. In some embodiments the primary site will wait for every requested timestamp 201 to be received before proceeding. However, in other embodiments the primary site may proceed after receiving at block 306 only a subset of the requested timestamps 201. If no initial replication at block 303 took place after inserting the local timestamp 201 into the folder 200 at the primary site 100 at block 301, then the remote sites 101 might generate an error indicating its version of the folder 200 contains no timestamp 201. Additionally, received timestamps may be stored at block 306, either inside or outside of the folder 200, to be used later for comparative or statistical purposes as indicated at block 307.

Requesting and receiving timestamps in block 305, 306 may comprise requesting and receiving using native filesystem file transfer operations or calls, interprocess communication requests, application programming interface (API) calls, or any other suitable messaging or programmatic communication mechanism.

The received timestamps are compared at block 307 to the local timestamp 201 of the primary site 100. If the difference between the timestamps exceeds a threshold value, a system event will be generated at block 308. In some embodiments the threshold value could be represented as UTC seconds; however other representations of time will work equally as well.

The received timestamps indicate the last time the folder 200 was replicated at block 303 to the remote site which sent the timestamp 201. Therefore, the difference at block 307 between the last time the local timestamp 201 was updated at the primary site 100 and the last time replication (block 303) occurred at the remote site 101 indicates a measurement of the replication lag for that remote site. Furthermore, since the primary site 100 initially generated all the timestamps at block 300, the comparison at block 307 will be valid regardless of the mechanism the remote site uses to keep track of time. Additionally, some embodiments will wait until all of the requested timestamps are received at block 306 and complete multiple comparisons at block 307 at once. In other embodiments, each received timestamp at block 306 can be compared at block 307 individually to the local timestamp 201 at the primary site 100 as each is received.

Furthermore, in some embodiments the threshold value may be static. Meanwhile, other embodiments might use statistical methods to create a threshold value that might change over time depending on the conditions of the network. For example, some embodiments may keep track of the mean and standard deviation of the recorded time differences and set the threshold at a specified number of standard deviations above the mean. The comparison at block 307 is effective regardless of how the threshold value is set. In an embodiment, the threshold value will be a reasonable estimation of when the replication delay between the primary site 100 and the remote sites 101 becomes unacceptable.

In some embodiments generating a system event at block 308 will cause an email or other notification to be sent to a system administrator informing them of the detected replication lag. In other embodiments a system event might prompt the use of other diagnostic tools to be run on the primary site 100 or the remote sites 101. However, the particular action a system chooses to perform at block 308 in response to the detection of replication lag is not critical and various embodiments may perform a variety of actions such as writing a log entry, updating a value in a management database such as an SNMP MIB, generating an alert message, sending an event on an event bus infrastructure, calling a function of an application programming interface or taking other programmatic action, or other action.

2.2 Remote Site Overview

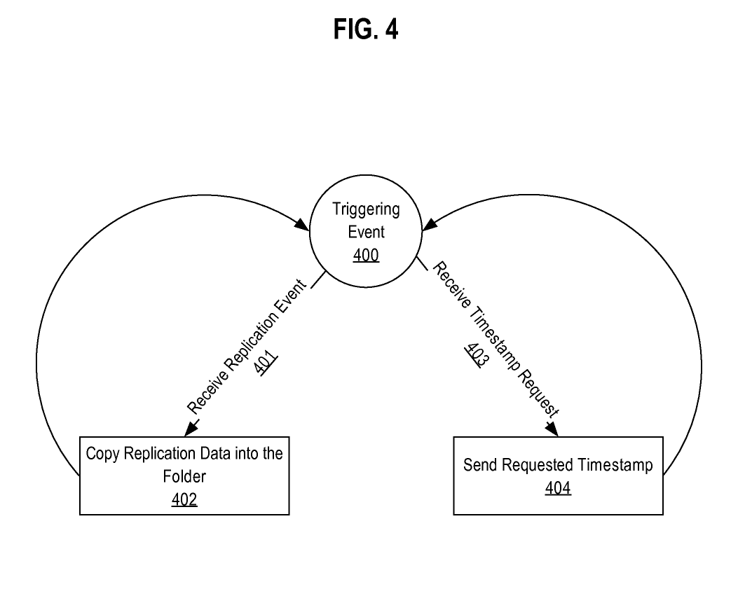

FIG. 4 illustrates an embodiment of a remote site in state diagram form.

Initially, at block 400, the remote sites start in a state where they wait for a triggering event. One potential triggering event at block 400 is a receive replication event. In one embodiment, a receive replication event 401 occurs when the remote site receives replication data from the primary site 100. In some embodiments, the replication data will represent a folder 200 and its associated files 207 to be replicated at the remote site. In other embodiments, the replication data may be only data blocks representing parts of the folder 200 and its files 207.

At block 402 the received replication data is copied into its associated folder 200. If the folder 200 does not yet exist on the remote site 102, the remote site 102 may create the folder 200 in response. Native filesystem operations, OS calls, API calls or other programmatic mechanisms may be used for this purpose.

Another potential triggering event at block 400 is that a remote site can receive timestamp request event 403 from the primary site 100. In some embodiments the timestamp request event 403 will encompass all the timestamps the primary site 100 has replicated 303 to the remote site 201. However, in other embodiments the timestamp request event 403 might ask for a specific timestamp 201.

Next, the timestamp file 201 which was requested at timestamp request event 403 by the primary site 100 is sent back at block 404 to the primary site 100. Sending a requested timestamp in block 404 may comprise requesting and receiving using native filesystem file transfer operations or calls, interprocess communication requests, application programming interface (API) calls, or any other suitable messaging or programmatic communication mechanism.

In some embodiments, another potential triggering event at block 400 may be a request replication event. A request replication event sends a message to the primary site 100 requesting a replication. The message may request that the primary site 100 replicate to the remote site 201 specific files or folders. Alternatively, the message may request that the primary site 100 replicate to the remote site 201 without indicating any particular files or folders. In such embodiments, the primary site 100 may decide which files or folders should be replicated to the remote site 201.

2.3 Alternative Embodiments of Primary and Remote Sites

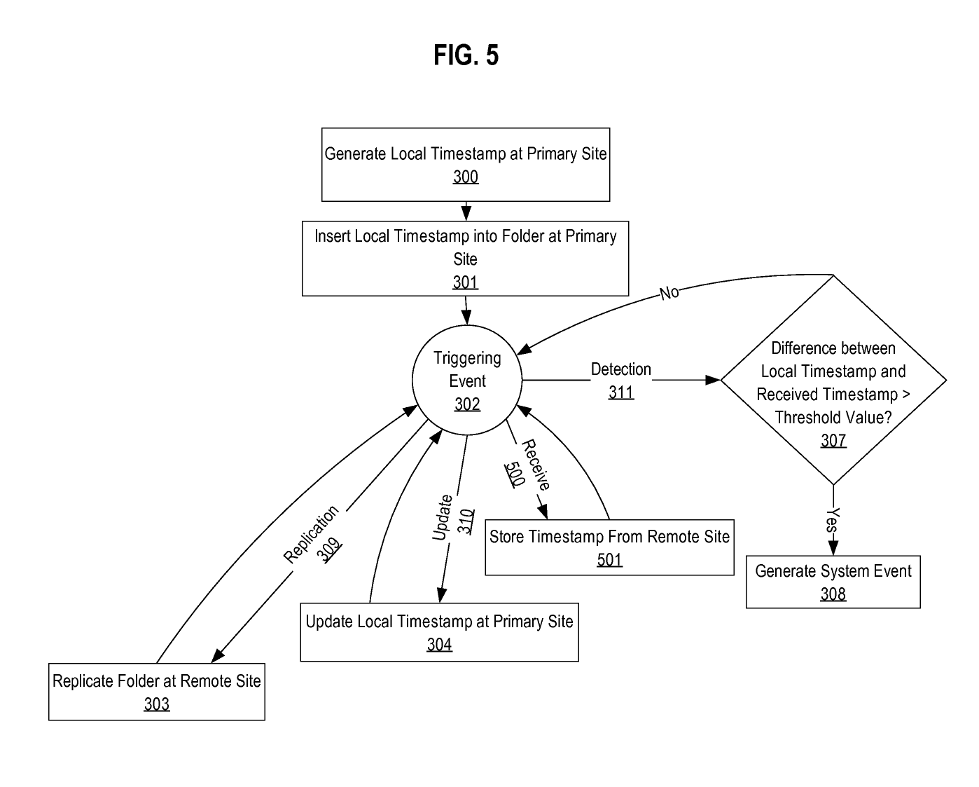

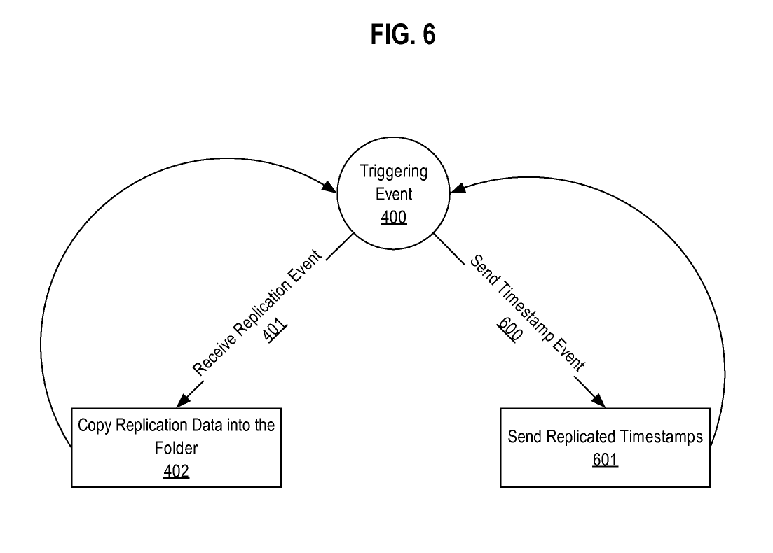

FIG. 5 illustrates an alternative embodiment of the primary site in state diagram form. FIG. 6 illustrates an alternative embodiment of the remote site in state diagram form. In one alternative design, rather than the primary site 100 requesting the timestamps back from the remote sites 101 at block 305, the remote sites 101 can instead implement logic to push their version of the remote timestamp 201 back to the primary site 100.

In this alternative design, the primary site 100 will follow the same processes described above with the following alternative processes.

Another potential triggering event 302 can be a receive triggering event 500. In one embodiment the receive triggering event 500 can comprise receiving back from a remote site a timestamp 201 which was previously replicated at block 303 to the remote site. In other embodiments, a receive triggering event 500 can be receiving back multiple timestamps from a remote site.

Next, the primary site 100 can store the received timestamp at block 501. In some embodiments the received timestamp may be stored at block 501 persistently in non-volatile memory; in others the received timestamp may be stored in volatile memory. In an embodiment, the received timestamp may be stored in the folder 200 at the primary site 100. However, in some embodiments the received timestamp may share the same name as the local timestamp. In such embodiments, the primary site 100 may rename the received timestamp so as to not overwrite the local timestamp in the folder 200 at the primary site 100.

The result of a detection triggering event 311 can then omit the steps of requesting at block 305 and receiving at block 306 the timestamps 201 from the remote sites 101. Instead, the comparison at block 307 of the timestamps 201 can simply use the received timestamps 201 that were previously stored at block 501.

Referring now to FIG. 6, in this alternative embodiment, the remote sites 101 will follow the same processes described above with the following alternative processes.

Rather than a receive request event 403, the remote site 102 can have a send timestamp event 600. In some embodiments a send timestamp event 600 can occur every set period of time. In other embodiments a send timestamp event 600 might be generated based upon the last time the remote site 102 has received the receive replication event 401. Since it is anticipated that a send timestamp event 600 can occur at any time, the specifics of how and when a system chooses to generate its send timestamp events 600 are not critical.

The result of a send timestamp event 600 is that the remote site 102 will send back at block 601 the timestamps which had been replicated at block 402 to the remote site 102. In some embodiments, sending at block 601 might involve sending back all the timestamps which had been replicated at block 402 to the remote site. In other embodiments the remote site may send back a single or a subset of the replicated timestamps.

2.4 Preventively Detecting Replication Lag

In some situations, an administrator of a replication system may be interested in detecting replication lag before sizable replications take place, as opposed to detecting that any particular replication itself is lagged. Depending on how the replication triggering events 309 and update triggering events 310 are generated, the aforementioned processes enable such detection.

File systems may be based on a block device that reads and writes in blocks of data. Each file on the file system may comprise many blocks, each of which may be a sequence of bytes or bits having a common length, referred to as a block size. Many replication mechanisms, including rsync, will detect which data blocks for files in the folder have been modified since the last replication, and will exchange only the modified blocks rather than copying over the entire folder during every replication. If no data blocks have been modified when the replication mechanism is invoked, no data files will be copied over and thus no actual replication will take place.

In an embodiment, if the only file that has been modified between two sequential replication triggering events 309 is the timestamp 201, then only the timestamp 201 will be sent during the subsequent replication at block 303. In other words, if the update event 310 and replication triggering event 309 are set to occur more often than modifications to the non-timestamp files 202 in the folder, then replications will occur which otherwise would not occur in the absence of including the timestamp 201 for diagnostic purposes.

These replications can then be measured as described above for replication lag. Since the timestamps may take up very little storage space and require minimal resources to process and send across a network, they provide the opportunity for monitoring the replication lag of the system before real replication is required.

For example, if the update events 310 and replication triggering events 309 are set to occur every minute, then a replication would occur at least every minute regardless of whether the non-timestamp files have been modified during that time. Thus, it is possible to use those replications to obtain continuous readings of the replication lag for the system without waiting for real replications to occur before a problem can be detected.

2.5 Detecting Replication Lag in a Peer to Peer System

In some embodiments, there are no primary sites 100. Instead, each site has the potential to modify its own files 207 and those modifications need to be propagated to the other sites. As an overview, in this configuration, each site will act as a primary site 100 for its own replications, and as a remote site 102 for replications at block 303 that are initiated by other sites. As such, each site will incorporate the structure of the primary site 100 as well as the structure of the remote sites 101 described above.

Preferably, although not necessarily, each site when generating its own timestamps 201 at block 300 will give its timestamp 201 a unique name to prevent it from conflicting or being overwritten by replications at block 303 initiated by other sites which also have generated timestamps at block 300. In one embodiment, determining a unique name can be accomplished by appending to the name of each timestamp 201 a unique ID related to the site for each timestamp 201 the site generates at block 300.

In an embodiment, during replications at block 303 between a site initiating a replication and a site receiving the replicated data at event 401, the receiving site will only overwrite a timestamp file if the received timestamp indicates a time later than the timestamp it already has.

In some embodiments this process may be combined with aspects of transaction processing systems in order to resolve cases where two or more sites may have conflicting modifications to the same non-timestamp file 203. However, replication lag can still be measured regardless of which modification prevails for the non-timestamp files 203. Each timestamp 201 held by a site will indicate the last time replicated data was received via a receive replication event 401 that originated from the site which generated 300 that timestamp 201. Although some of that data might be rejected according to the rules of the transaction processing system, the difference between the timestamps will still indicate a measurement of when that the data was considered. Therefore, the comparison at block 307 will still be a valid measurement of replication lag.

3.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

4.0 Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer implemented method for detecting replication lag comprising:
generating and storing a local timestamp in an electronic folder at a first computer;
in response to a replication triggering event, replicating the electronic folder, including the local timestamp generated by the first computer, to at-one or more target computers;
in response to a update triggering event, updating the local timestamp in the electronic folder at the first computer;
in response to a detection triggering event, the first computer requesting and receiving at least a portion of the electronic folder representing the local timestamp generated by the first computer from at least one target computer of the one or more target computers; and
in response to determining that the time difference between one or more of the received timestamps and the local timestamp exceeds a threshold value, the first computer generating a system event.

2. The computer implemented method of claim 1, further comprising periodically generating the replication triggering event, update triggering event, and detection triggering event.

3. The computer implemented method of claim 1, further comprising generating a replication triggering event based on inserting the local timestamp into the electronic folder.

4. The computer implemented method of claim 1, wherein the local timestamp represents Coordinated Universal Time (UTC) seconds.

5. The computer implemented method of claim 1, further comprising persistently storing at least a representation of the time difference between one or more of the received timestamps and the local timestamp.

6. The computer implemented method of claim 5, wherein the threshold amount is based at least in part upon the previously stored representations of the time differences.

7. The computer implemented method of claim 1, wherein the replicating is performed by a replication mechanism that the first computer and the one or more target computers have previously implemented for general purpose file replication.

8. The computer implemented method of claim 1, wherein the electronic folder contains files other than the local timestamp and the files remain unmodified between two sequential replication triggering events.

9. The computer implemented method of claim 1, further comprising:
receiving a second portion of an electronic folder containing at least a second timestamp from a second target computer of the one or more target computers;
in response to receiving a request from the second target computer, sending the second timestamp to the second target computer.

10. A non-transitory computer-readable medium carrying one or more sequences of instructions, which when executed by one or more processors, cause the one or more processors to carry out the steps of:
generating and storing a local timestamp in an electronic folder at a first computer;
in response to a replication triggering event, replicating the electronic folder, including the local timestamp generated by the first computer, to at-one or more target computers;
in response to a update triggering event, updating the local timestamp in the electronic folder at the first computer;
in response to a detection triggering event, the first computer requesting and receiving at least a portion of the electronic folder representing the local timestamp generated by the first computer from at least one target computer of the one or more target computers; and
in response to determining that the time difference between one or more of the received timestamps and the local timestamp exceeds a threshold value, the first computer generating a system event.

11. The non-transitory computer readable medium of claim 10, further comprising periodically generating the replication triggering event, update triggering event, and detection triggering event.

12. The non-transitory computer readable medium of claim 10, further comprising generating a replication triggering event based on inserting the local timestamp into the electronic folder.

13. The non-transitory computer readable medium of claim 10, wherein the local timestamp represents Coordinated Universal Time (UTC) seconds.

14. The non-transitory computer readable medium of claim 10, further comprising persistently storing at least a representation of the time difference between one or more of the received timestamps and the local timestamp.

15. The non-transitory computer readable medium of claim 14, wherein the threshold amount is based at least in part upon the previously stored representations of the time differences.

16. The non-transitory computer readable medium of claim 10, wherein the replicating is performed by a replication mechanism that the first computer and the one or more target computers have previously implemented for general purpose file replication.

17. The non-transitory computer readable medium of claim 10, wherein the electronic folder contains files other than the local timestamp and the files remain unmodified between two sequential replication triggering events.

18. The non-transitory computer readable medium of claim 10, further comprising:
receiving a second portion of an electronic folder containing at least a second timestamp from a second target computer of the one or more target computers;
in response to receiving a request from the second target computer, sending the second timestamp to the second target computer.

19. An apparatus comprising:
a processor;
one or more stored sequences of instructions which, when executed by the processor, cause the processor to perform:
generating and storing a local timestamp in an electronic folder at a first computer;
in response to a replication triggering event, replicating the electronic folder, including the local timestamp generated by the first computer, to at-one or more target computers;
in response to a update triggering event, updating the local timestamp in the electronic folder at the first computer;
in response to a detection triggering event, the first computer requesting and receiving at least a portion of the electronic folder representing the local timestamp generated by the first computer from at least one target computer of the one or more target computers; and
in response to determining that the time difference between one or more of the received timestamps and the local timestamp exceeds a threshold value, the first computer generating a system event.

20. The apparatus of claim 19, further comprising periodically generating the replication triggering event, update triggering event, and detection triggering event.

21. The apparatus of claim 19, further comprising generating a replication triggering event based on inserting the local timestamp into the electronic folder.

22. The apparatus of claim 19, wherein the local timestamp represents Coordinated Universal Time (UTC) seconds.

23. The apparatus of claim 19, further comprising persistently storing at least a representation of the time difference between one or more of the received timestamps and the local timestamp.

24. The apparatus of claim 23, wherein the threshold amount is based at least in part upon the previously stored representations of the time differences.

25. The apparatus of claim 19, wherein the replicating is performed by a replication mechanism that the first computer and the one or more target computers have previously implemented for general purpose file replication.

26. The apparatus of claim 19, wherein the electronic folder contains files other than the local timestamp and the files remain unmodified between two sequential replication triggering events.

27. The apparatus of claim 19, further comprising:
receiving a second portion of an electronic folder containing at least a second timestamp from a second target computer of the one or more target computers;
in response to receiving a request from the second target computer, sending the second timestamp to the second target computer.
